(19) United States
(12) Patent Application Publication
(10) Pub. No.: US 2006/0230283 A1
(43) Pub. Date: Oct. 12, 2006

(54) Changing passwords with failback

(75) Inventors: Thomas Marcus McBride, Mantorville, MN (US); Michael Francis Moriarty, Byron, MN (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/100,948

(22) Filed: Apr. 7, 2005

(51) Int. Cl. H04K 1/00

(52) U.S. Cl. 713/184

(57) ABSTRACT

Changing a user's current password for accessing a computer resource, including establishing a provisional password for the user for accessing the computer resource and replacing the user's current password with the provisional password in dependence upon decision criteria. Typical embodiments also include replacing the user's current password with the provisional password if the user enters the provisional password in a subsequent request to access the computer resource. Further embodiments include replacing the user's current password with the provisional password if the user enters the provisional password in a subsequent request to access the computer resource, and if the subsequent request occurs within a time period. Typical embodiments also include discarding the provisional password if the user does not enter the provisional password in a subsequent request to access the computer resource, and establishing a new provisional password for the user for accessing the computer resource.

### BACKGROUND OF THE INVENTION

1. Field of the Invention

The field of the invention is data processing, or, more specifically, methods, systems, and products for changing a user's current password for accessing a computer resource.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Passwords are frequently used to authenticate users requesting access to computer resources. Authentication is the process of reliably verifying the identity of a user of a computer resource and may be accomplished through the use of various authentication protocols. One such example of an authentication protocol is the password authentication protocol (‘PAP’). PAP is generally implemented by a password administration module which administers authentication according to the protocol. The password administration module may be installed on a computer to administer authentication locally or may be installed on a server or gateway to administer network-wide authentication.

A password administration module operating according to PAP receives and stores a password for a user for a computer resource in association with a user ID that uniquely identifies the user. The password is typically stored in a password table in a password file located in data storage accessible to the password administration module. For further security, password administration modules often encrypt the password and store the encrypted password in the password table. And to provide even further security, many password administration modules encrypt the password file itself.

To grant access to a user to the password protected computer resource, password administration modules verify the user's identity by comparing a user ID and password received with a request for access to the resource with the user ID and password stored in the password table. In the case of encrypted passwords, the password administration module may be required to decrypt the password table or password file prior to comparing the stored password with the password received with the request for access to the computer resource. In some cases, password administration modules encrypt the received password and then compare the encrypted stored password and the encrypted received password. Comparing the encrypted stored password and the encrypted received password advantageously reduces the frequency of use of the unencrypted password and reduces the presence of the unencrypted password in memory.

Passwords are frequently user selected because user-selected passwords are often more easily remembered by the user. To enhance security however, password administration modules permit or periodically require a user to change their password. After verifying the user's identity, the password administration module usually establishes a new password for the user by prompting the user to enter a new password often comprising a set of characters that the user intends to be a new password. The password administration module then disables the current password, stores the new set of characters as the new password, and activates the new password to provide access to the computer resource.

Occasionally when a user of a computer resource changes a password, the new password established by the password administration module does not match the intended password of the user. This result might occur because the user miss-keyed the intended character set comprising the new password upon establishing the new password and is unable to reproduce the miss-keyed sequence at a subsequent request for access to the computer resource. The password mismatch might also occur because electronic data representing the new password is corrupted during transmission from the user through a data communications network to the computer system. In either case, the user is locked out from accessing the computer resource. To regain access to the computer resource, a user must typically contact a helpdesk operated by a human administrator empowered to reset the user's password. Proper setup and maintenance of these helpdesks can however be quite expensive.

Current methods for changing a user's password guard against a user miss-keying the new password by having the user enter the new password twice. Requiring a user to enter the new password twice does reduce the frequency of a user miss-keying the new password. However, users often incorrectly key the password twice. Users may incorrectly key the password twice, for example, when the user enters the password in close succession without removing the user's hands from the keyboard. Furthermore, requiring a user to enter the password twice is cumbersome for a user.

### SUMMARY OF THE INVENTION

Methods, apparatuses, and products are provided for changing a user's current password for accessing a computer resource that reduces the probability that a user will be locked out from accessing the computer resource, reduces helpdesk requirements, and appears less cumbersome to the user. More particularly, methods, systems, and products are disclosed for changing a user's current password for accessing a computer resource that includes establishing a provisional password for the user for accessing the computer resource and replacing the user's current password with the provisional password in dependence upon decision criteria.

In typical embodiments, replacing the user's current password with the provisional password in dependence upon decision criteria includes replacing the user's current password with the provisional password if the user enters the provisional password in a subsequent request to access the computer resource. Typical embodiments of replacing the user's current password with the provisional password in dependence upon decision criteria also include replacing the user's current password with the provisional password if the user enters the provisional password in a subsequent request to access the computer resource, and if the subsequent request occurs within a time period. Further typical embodiments of replacing the user's current password with the provisional password in dependence upon decision criteria includes discarding the provisional password if the user does not enter the provisional password in a subsequent request to access the computer resource, and establishing a new provisional password for the user for accessing the computer resource. In typical embodiments, replacing the user's current password with the provisional password in dependence upon decision criteria further includes discarding the provisional password if a subsequent request to access the computer resource does not occur within a time period, and establishing a new provisional password for the user for accessing the computer resource.

In other embodiments, establishing a provisional password for the user for accessing the computer resource includes verifying a user's identity in response to a user's request to access the computer resource, receiving from the user a set of characters, and storing the set of characters as a provisional password.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for changing a user's current password for accessing a computer resource according to embodiments of the present invention.

FIG. 2 sets forth a block diagram of automated computing machinery comprising an exemplary computer useful in changing a user's current password for accessing a computer resource according to embodiments of the present invention.

FIG. 3 sets forth a flow chart illustrating an exemplary method for changing a user's current password for accessing a computer resource.

FIG. 4 sets forth a flow chart illustrating an exemplary method for establishing a provisional password for the user for accessing the computer resource.

FIG. 5 sets forth a flow chart illustrating an exemplary method for replacing the user's current password with the provisional password in dependence upon decision criteria.

FIG. 6 sets forth a flow chart illustrating another exemplary method for replacing the user's current password with the provisional password in dependence upon decision criteria.

FIG. 7 sets forth a flow chart illustrating another exemplary method for replacing the user's current password with the provisional password in dependence upon decision criteria.

FIG. 8 sets forth a flow chart illustrating another exemplary method for replacing the user's current password with the provisional password in dependence upon decision criteria.

### DETAILED DESCRIPTION OF EXEMPLARY EMBODIMENTS

### Introduction

The present invention is described to a large extent in this specification in terms of methods for changing a user's current password for accessing a computer resource. Persons skilled in the art, however, will recognize that any computer system that includes suitable programming means for operating in accordance with the disclosed methods also falls well within the scope of the present invention. Suitable programming means include any means for directing a computer system to execute the steps of the method of the present invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Changing Passwords with Failback

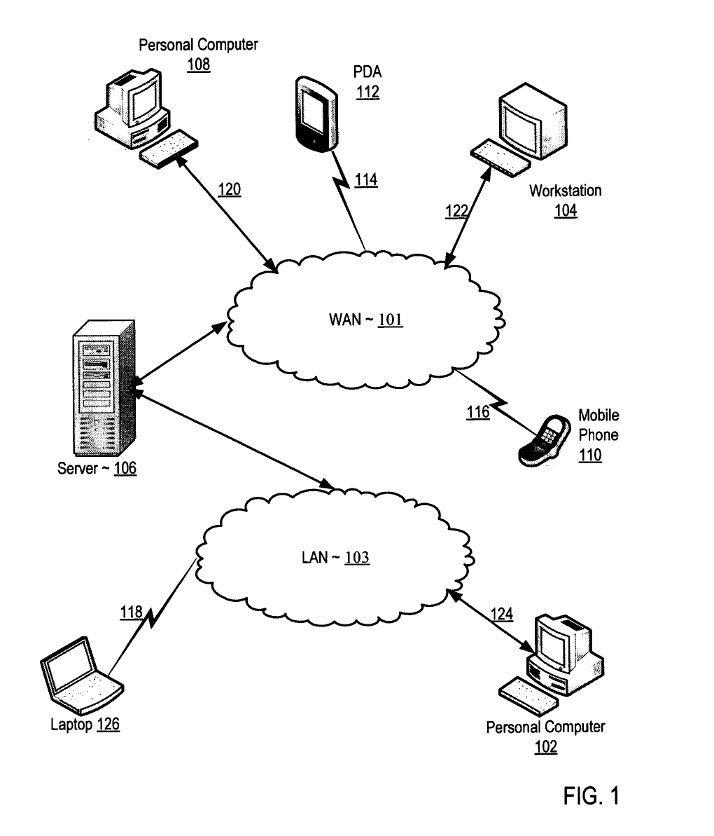

Exemplary methods, systems, and products for changing a user's current password for accessing a computer resource according to embodiments of the present invention are described with reference to the accompanying drawings, beginning with FIG. 1. FIG. 1 sets forth a network diagram illustrating an exemplary system for changing a user's current password for accessing a computer resource according to embodiments of the present invention. The system of FIG. 1 operates generally to change a user's current password for accessing a computer resource according to embodiments of the present invention by establishing a provisional password for the user for accessing the computer resource and replacing the user's current password with the provisional password in dependence upon decision criteria.

The system of FIG. 1 includes a number of computers connected for data communications in networks. Each of the computers of the system of FIG. 1 may have a password administration module installed upon it capable of changing a user's current password for accessing a computer resource according to the present invention. The data processing system of FIG. 1 includes wide area network (“WAN”) (101) and local area network (“LAN”) (103). The network connection aspect of the architecture of FIG. 1 is only for explanation, not for limitation. In fact, systems for changing a user's current password for accessing a computer resource according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, several exemplary devices including a PDA (112), a computer workstation (104), a mobile phone (110), and personal computer (108) are connected to WAN (101). Network-enabled mobile phone (110) connects to WAN (101) through wireless link (116), and PDA (112) connects to network (101) through wireless link (114). In the example of FIG. 1, personal computer (108) connects through wireline connection (120) to WAN (101), and computer workstation (104) connects through wireline connection (122) to WAN (101). Laptop (126) connects through wireless link (118) to LAN (103), and personal computer (102) connects through wireline connection (124) to LAN (103). Server (106) implements a gateway, router, or bridge between LAN (103) and WAN (101).

In the system of FIG. 1, each of the exemplary devices (108, 112, 104, 110, 126, 102, and 106) supports a password administration module capable of changing a user's current password for accessing a computer resource that includes establishing a provisional password for the user for accessing the computer resource. A computer resource may be any computer resource. That is, in this specification ‘computer resource’ or ‘resource’ refers to any aggregation of information that may be password protected or any computer system for accessing such aggregations of information that may be password protected. The most common kind of such an aggregation of information is a file, but such resources may also include dynamically-generated query results as well, such as the output of CGI (‘Common Gateway Interface’) scripts, Java servlets, dynamic server pages, documents available in several languages, and so on. In effect, such resources are somewhat similar to files, but more general in nature. Resources implemented as files include static web pages, graphic image files, video clip files, audio clip files, and so on. As a practical matter, most resources that are aggregations of information are currently either files or server-side script output or any computer system for accessing those files or server-side script output. Server-side script output includes output from CGI programs, Java servlets, Active Server Pages, Java Server Pages, and so on. A computer resource may also include any of the computer systems or networks for accessing aggregations of information. Such computer resources include any component of computers or networks such as disk drives, printers, displays, memory, computer processors, or any other components as will occur to those of skill in the art.

A provisional password is typically implemented as set of characters intended by the user to be a new password for accessing the computer resource. A provisional password is provisional because the provisional password is established but does not immediately replace the user's current password. The current password is instead replaced by the provisional password in dependence upon decision criteria as discussed in more detail below.

Decision criteria are replacement conditions governing the replacing of a current password with an established provisional password. Decision criteria often include one or more decision rules that govern the replacing of a current password with an established provisional password. Decision criteria therefore advantageously provides failback for the provisional password. One example of a decision rule is a rule defining a replacement condition such that if a user enters the established provisional password in subsequent request to access a computer resource, then the provisional password replaces the current password. Such exemplary decision criteria requires a user to twice correctly enter a password that the user intended to be a new password while making the second entry of the new password transparent to the user. The user enters the provisional password twice by entering the provisional password first upon establishing the provisional password and second upon a subsequent request to access the resource.

Until the decision criteria are met, password administration modules operating in accordance with the present invention will typically authenticate the user with either the provisional password or the current password. That is, both passwords provide access to the computer resource until decision criteria are met, but after decision criteria are satisfied, the provisional password alone provides access to the computer resource as the new current password.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

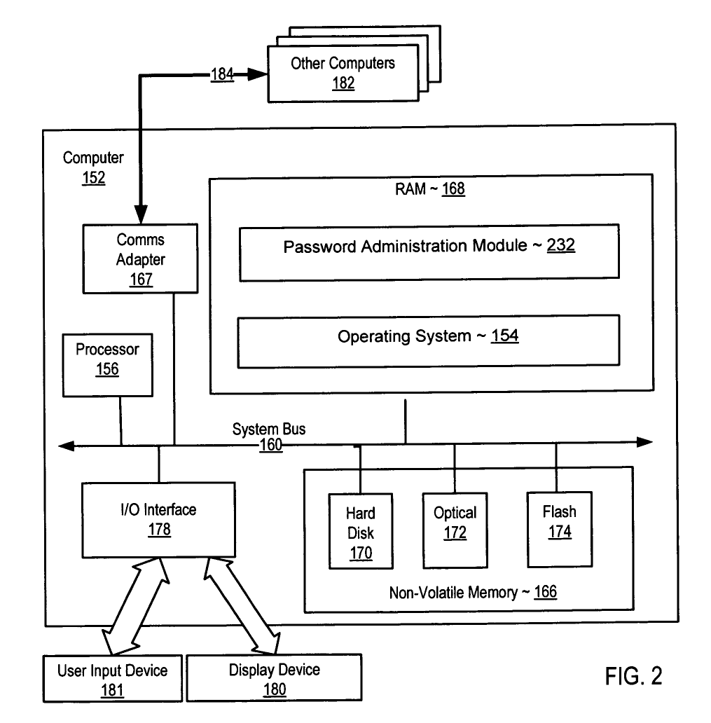

Changing a user's current password for accessing a computer resource in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in changing a user's current password for accessing a computer resource according to embodiments of the present invention. The computer (152) of FIG. 2 includes at least one computer processor (156) or ‘CPU’ as well as random access memory (168) (“RAM”) which is connected through a system bus (160) to processor (156) and to other components of the computer.

Stored in RAM (168) is a password administration module (232). The password administration module (232) of FIG. 2 includes computer program instructions for changing a user's current password for accessing a computer resource that includes computer program instructions that establish a provisional password for the user for accessing the computer resource and computer program instructions that replace the user's current password with the provisional password in dependence upon decision criteria. Decision criteria therefore advantageously provides failback for the provisional password.

Also stored in RAM (168) is an operating system (154). Operating systems useful in computers according to embodiments of the present invention include UNIX™, Linux™, Microsoft NT™, AIX™, IBM's i5/OS™, and others as will occur to those of skill in the art. Operating system (154) and password administration module (232) in the example of FIG. 2 are shown in RAM (168), but many components of such software typically are stored in non-volatile memory (166) also.

Computer (152) of FIG. 2 includes non-volatile computer memory (166) coupled through a system bus (160) to processor (156) and to other components. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

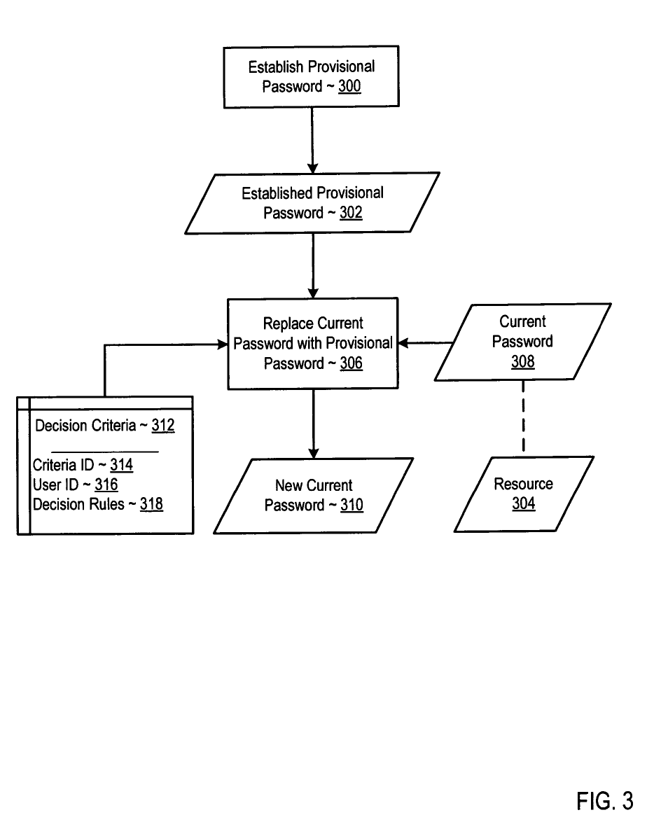

For further explanation, FIG. 3 sets forth a flow chart illustrating an exemplary method for changing a user's current password (308) for accessing a computer resource (304). The method of FIG. 3 includes establishing (300) a provisional password (302) for the user for accessing a computer resource (304) and replacing (306) the user's current password (308) with the provisional password (302) in dependence upon decision criteria (312).

As discussed above, a provisional password is typically a set of characters intended by the user to be a new password for accessing the computer resource. A provisional password is provisional because the provisional password according to the method of FIG. 3 does not immediately replace the user's current password (308). The current password is instead replace by the provisional password in dependence upon decision criteria (312) as discussed in more detail below.

Decision criteria (312) are replacement conditions governing the replacing (306) of a current password (308) with an established provisional password (302). Decision criteria (312) often include one or more decision rules (318) that govern the replacing (306) of a current password (308) with an established provisional password (302). One example of such a decision rule (318) is a rule defining a replacement condition such that if a user enters the established provisional password (302) in subsequent request to access a computer resource (304), then the provisional password replaces the current password. Such exemplary decision criteria requires a user to twice correctly enter a password that the user intended to be a new password while making the second entry of the new password transparent to the user. The user enters the provisional password twice by entering the provisional password first upon establishing the provisional password and second upon a subsequent request to access the resource.

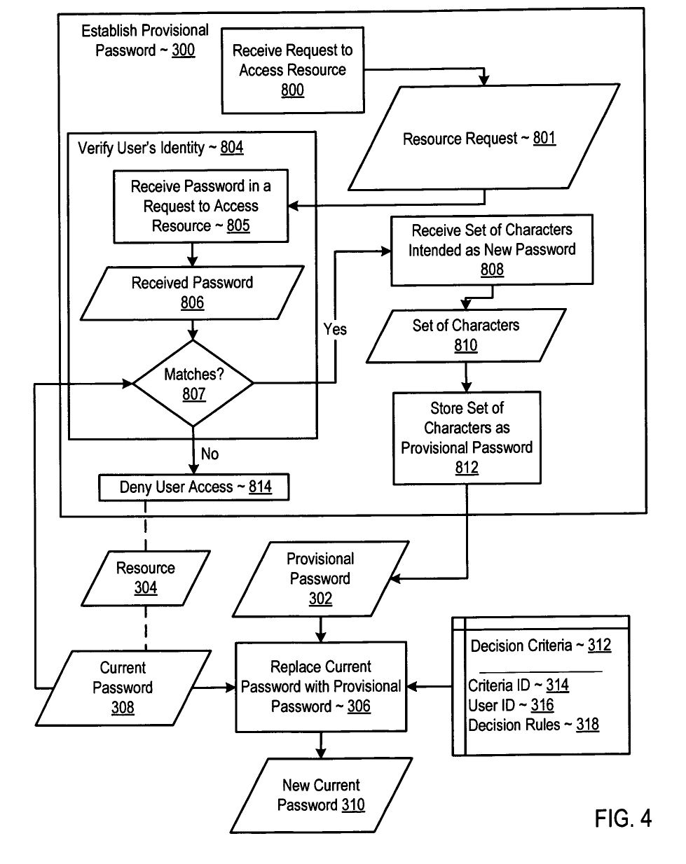

Establishing (300) a provisional password (302) according to the method of FIG. 3 may be carried out by prompting a user to enter a new password, receiving from a user in response to the prompt a set of characters intended by the user to be a new password, and storing the set of characters as a provisional password (302). For further explanation, FIG. 4 below sets forth a flow chart illustrating an exemplary method for establishing (300) a provisional password (302). In the example of FIG. 4, establishing (300) a provisional password (302) for the user for accessing the computer resource (304) includes receiving (800) a request (801) from a user to access a computer resource (304). The user's request (801) to access a computer resource (304) may include a request for logging onto to a computer terminal, a request for accessing a stored file, a request for sending electronic data through a computer gateway, or any other request to access a computer resource that will occur to those of skill in the art.

The example of FIG. 4 further includes verifying (804) the user's identity in response to a request (801) to access a computer resource (304). Verifying (804) a user's identity may be carried out by receiving (805) a set of characters from the user comprising a password (806). Such a password may be received from a user in response to prompting the user for a password, upon the user's own motion, or any other way that will occur to those of skill in the art. To enhance security for accessing the computer resource, the received set of characters may be transmitted from the user using data encryption techniques such as shared secret keys, public keys, one-way public keys, or any other encryption technique as will occur to those of skill in the art.

Verifying (804) the user's identity according to the method of FIG. 4 also includes determining (807) whether the received password (806) matches the current password (308) stored for the user requesting access to the computer resource (304). If the received password (806) matches the current password (308) stored for the user, then the method of FIG. 4 includes receiving (808) a set of characters (810) from the user intended by the user to be a new current password. The set of characters (810) may be received in response to prompting the user for a new password, upon the user's own motion, or any other method that will occur to those of skill in the art. Receiving (808) from the user a set of characters (810) intended by the user to be a new password may include enforcing certain password constraints such as limiting the number of received characters, ensuring the received characters comprise predetermined letters, numerals, or other special characters, or any other constraint as will occur to those of skill in the art.

The example of FIG. 4 also includes storing (812) the set of characters (810) received from the user and intended by the user to be a new password as a provisional password (302). As discussed above, a provisional password is typically a set of characters intended by the user to be a new password for accessing the computer resource. A provisional password is provisional because the provisional password according to the method of FIG. 4 does not immediately replace the user's current password (308). The current password is instead replaced by the provisional password in dependence upon decision criteria (312) as discussed in more detail below. The provisional password (302) may be stored in a password table in a password file formatted as clear-characters, as a cryptographic hash, or in any other format that will occur to those of skill in the art. To further enhance security for accessing the computer resource (304), the password file may also be encrypted using data encryption techniques such as translation tables, data repositioning, XOR bit masking, or others as will occur to those of skill in the art.

If the received password (806) does not match the current password (308) stored for the user, then the method of FIG. 4 is carried out by denying (814) the user access to the computer resource (304). After denying (814) the user access to the computer resource, the example of FIG. 4 may include re-prompting the user for the user's current password until the user's identity can be verified.

In the example of FIG. 4, verifying (804) the user's identity is carried out by determining (807) whether the received password (806) matches the current password (308) stored for the user. This is for explanation, and not for limitation. In fact, verifying (804) the user's identity may be carried out in other ways such as through biometric authentication, voice authentication, or any other way of authentication that will occur to those of skill in the art.

Again with reference to FIG. 3: FIG. 3 includes replacing (306) the user's current password (308) with the provisional password (302) in dependence upon decision criteria (312). As discussed above, decision criteria are replacement conditions governing the replacing of a current password with an established provisional password. Decision criteria often include one or more decision rules that govern the replacing of a current password with an established provisional password.

If decision criteria are met, replacing (306) the user's current password (308) with the provisional password (302) may include disabling the user's current password (308), saving the provisional password (302) as a new current password (310), and activating the new current password (310) thereby enabling the new current password (310) to provide the user access to the computer resource (304). Saving the provisional password (302) as the new current password (310) may include storing the new current password (310) in a password table in a password file formatted as clear-characters, as a cryptographic hash, or in any other format that will occur to those of skill in the art. To further enhance security for accessing the computer resource (304), the password file may also encrypted using data encryption techniques such as translation tables, data repositioning, XOR bit masking, or others as will occur to those of skill in the art. The new current password (310) of FIG. 3 has the same authentication characteristics as the replaced current password (308).

In the example of FIG. 3, if the decision criteria are not met because the established provisional password (302) does not match a password received from the user at a subsequent request to access a computer resource (304), the current password (308) is not replaced by the provisional password (302). A user may therefore be granted access to the computer resource upon presenting the current password.

In the example of FIG. 3, decision criteria is represented in data as a decision criteria record (312). The exemplary decision criteria record includes a criteria ID (314) that uniquely identifies the decision criteria (312). The exemplary decision criteria record also includes a user ID (316) uniquely identifying a user for whom the decision criteria define replacement conditions for replacing the current password with an established provisional password. The exemplary decision criteria record (312) further includes a field containing decision rules (318).

In the example of FIG. 3, the decision criteria (312) includes a user ID (316). Such decision criteria therefore defines replacement conditions for a particular user. This is for explanation and not for limitation. In fact, decision criteria according to the method of FIG. 3 may not include a user ID (316) and may be implemented on a system wide basis. Decision criteria according to embodiments of the present invention may have varying scope from a single resource to many computer systems as will occur to those of skill in the art.

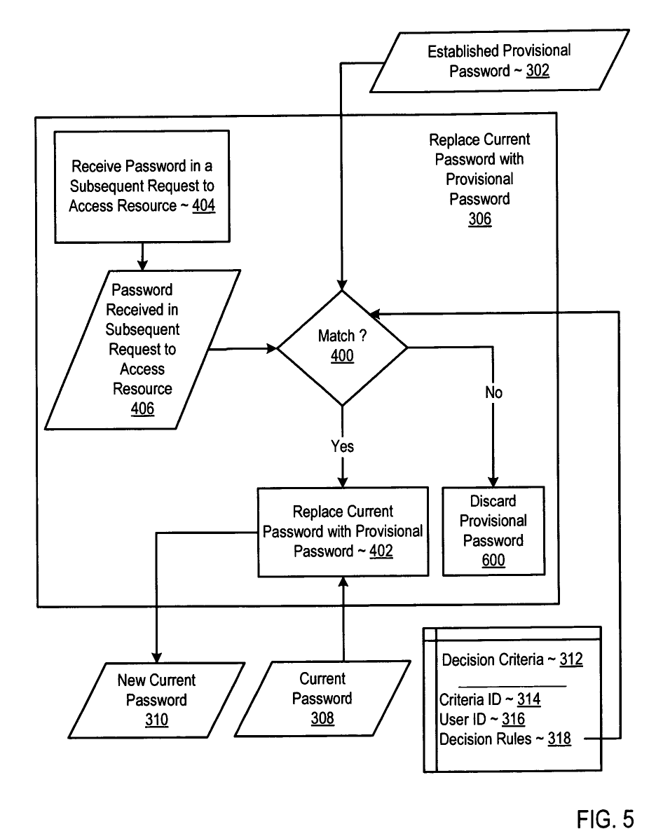

As discussed above, replacing (306) the user's current password (308) with the provisional password (302) occurs in dependence upon decision criteria (312). For further explanation, FIG. 5 sets forth a flow chart illustrating an exemplary method for replacing (306) the user's current password (308) with the provisional password (302) in dependence upon decision criteria (312), wherein that decision criteria includes decision rules requiring a user to enter the provisional password in a subsequent request to access the computer resource to replace the current password with the provisional password. The example of FIG. 5 effectively allows a user to change a current password if the user correctly enters the intended new password twice, and advantageously making the second entry of the user's intended new password transparent to the user.

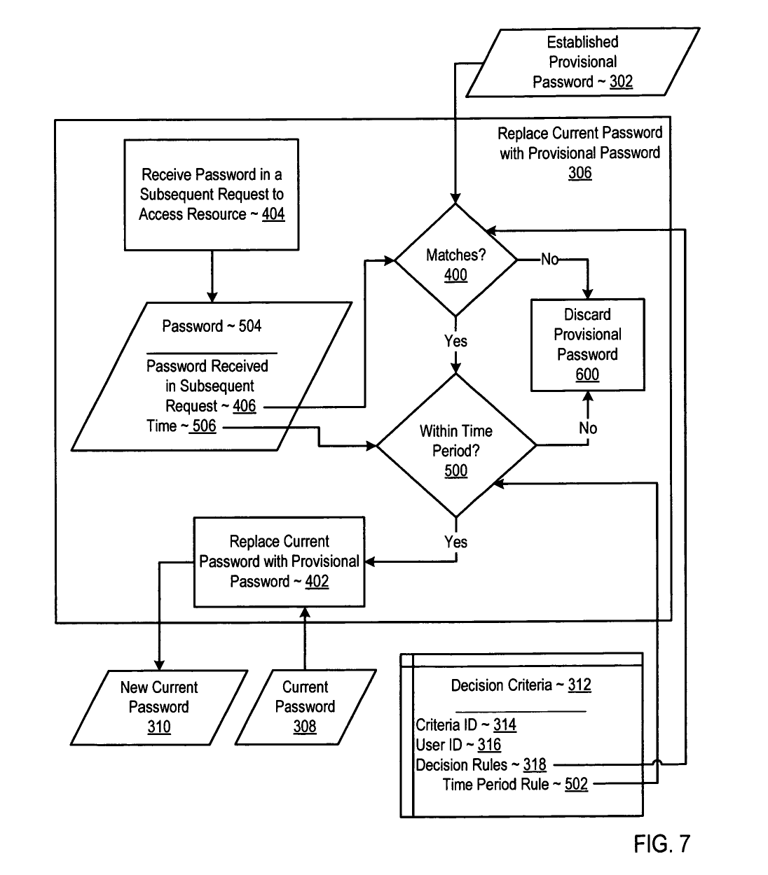

In the method of FIG. 5, replacing (306) the user's current password (308) with the provisional password (302) in dependence upon decision criteria (312) includes receiving (404) a password (406) in a subsequent request to access the computer resource. A subsequent request may be any request by the user to access the resource after establishing the provisional password (302). Subsequent requests according to the method of FIG. 5 may occur seconds, minutes, days, or years after establishing a provisional password (302). In fact, the timing of a subsequent request itself may be governed by one or more decision rules (318) in decision criteria (312) according to embodiments of the present invention and specifically discussed with reference to FIG. 7.

Receiving (404) a password (406) in a subsequent request to access the computer resource may include prompting a user to enter a password and receiving in response to such prompting a password intended by the user to be a password to access the resource. In the example of FIG. 5, a password received (406) in a subsequent request to access the computer resource is typically a set of characters entered by a user in response to prompting the user for a password. As mentioned above, the password received (406) may be transmitted from the user using data encryption techniques such as shared secret keys, public keys, one-way public keys, or any other encryption technique as will occur to those of skill in the art to enhance security.

After receiving (404) a password (406) in a subsequent request to access the computer resource, the method of FIG. 5 continues by determining (400) whether the password received (406) in a subsequent request matches the provisional password (302). Determining (400) whether the password received (406) in a subsequent request matches the provisional password (302) may be carried out by comparing the password received (406) in a subsequent request with the provisional password (302). If the password received (406) in a subsequent request matches the provisional password (302), then the method of FIG. 5 continues by replacing (402) the user's current password (308) with the provisional password (302). As mentioned above, replacing (402) the user's current password (308) with the provisional password (302) may include disabling the user's current password (308), saving the provisional password (302) as a new current password (310), and activating the new current password (310) thereby enabling the new current password (310) to provide the user access to the computer resource.

In the example of FIG. 5, the exemplary decision rules (318) dictate that a password received (406) in a single subsequent request for access to the resource matching the provisional password (302) is sufficient to replace the current password with the provisional password. This is for explanation, and not for limitation. In fact, password administration modules operating according to the method of FIG. 5 may implement decision rules that require more than a single subsequent request to replace the current password with the provisional password as will occur to those of skill in the art.

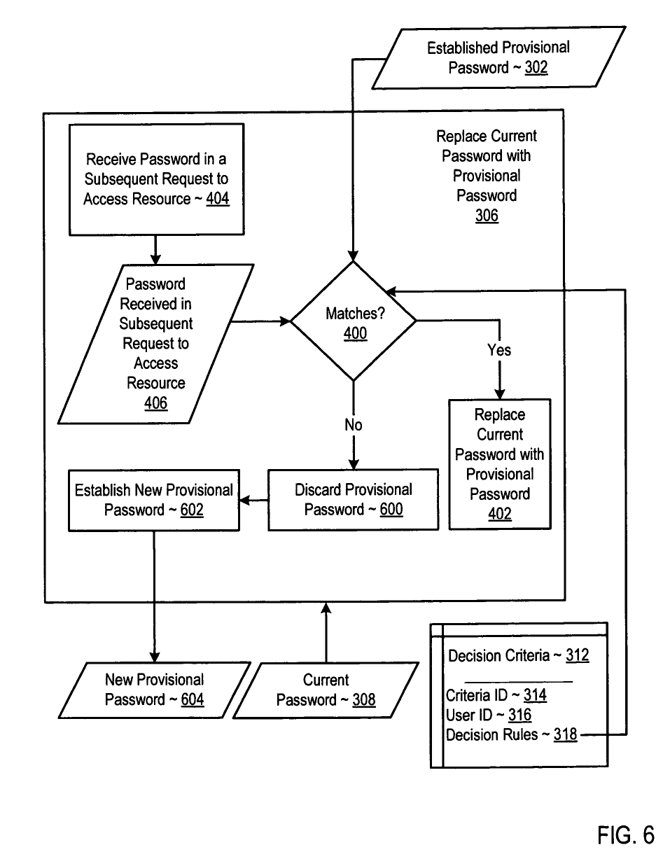

In the example of FIG. 5, the decision rules (318) require discarding (600) the provisional password (302) if the password received (406) in a subsequent request does not match the provisional password (302). Discarding (600) the provisional password (302) prevents authentication of the user's identity using the provisional password (302) and is described in more detail below in FIG. 6.

The example of FIG. 6 sets forth a flow chart illustrating an exemplary method for replacing (306) the user's current password (308) with the provisional password (302) in dependence upon decision criteria (312) that requires discarding (600) the provisional password (302) if the user does not enter the provisional password (302) in a subsequent request to access the computer resource, and establishing a new provisional password (604) for the user for accessing the computer resource. The example of FIG. 6 effectively prevents a user from changing a current password if the user cannot correctly enter the intended new password twice and allows the user another opportunity to change the current password by receiving another password intended by the user to be a new password.

In the method of FIG. 6, replacing (306) the user's current password (308) with the provisional password (302) in dependence upon decision criteria (312) includes receiving (404) a password (406) in a subsequent request to access the computer resource. After receiving (404) a password (406) in a subsequent request to access the computer resource, the method of FIG. 6 continues by determining (400) whether the password received (406) in a subsequent request matches the provisional password (302). Determining (400) whether the password received (406) in a subsequent request matches the provisional password (302) may be carried out by comparing the password received (406) in a subsequent request with the provisional password (302).

If the password received (406) in a subsequent request does not match the provisional password (302), then the method of FIG. 6 includes discarding (600) the provisional password (302). Discarding (600) the provisional password (302) prevents authentication of a user's identity using the provisional password (302). Discarding (600) the provisional password (302) according the method of FIG. 6 may include erasing the provisional password (302) from a storage location in computer memory, storing the provisional password as an old provisional password, disassociating the provisional password (302) from the user, or any other way as will occur to those of skill in the art.

After discarding (600) the provisional password (302), the method of FIG. 6 further includes establishing (602) a new provisional password (604). A new provisional password (604) is typically a set of characters received in response to prompting the user for a new password and intended by the user to be a new password for accessing the computer resource. As discussed above, the new provisional password (604) is provisional because the password administration module does not immediately replace the user's current password with the new provisional password (604) intended by the user to be the new password. Establishing (602) a new provisional password (604) according to the example of FIG. 6 may be carried out by prompting a user to enter a new password, receiving from a user in response to the prompt a set of characters intended by the user to be a new password, and storing the set of characters as a new provisional password (604).

As discussed above, decision criteria (312) may include timing requirements. For further explanation therefore, FIG. 7 sets forth a flow chart illustrating an exemplary method for replacing (306) the user's current password (308) with the provisional password (302) in dependence upon decision criteria (312) that implements a timing requirement (502) in addition to the requirement that a password (406) in a subsequent request to access the computer resource matches the provisional password (302). The example of FIG. 7 effectively allows a user to change a current password if the user correctly enters the intended new password twice within a predetermined time period, advantageously making the second entry of the user's intended new password transparent to the user.

In the method of FIG. 7, replacing (306) the user's current password (308) with the provisional password (302) in dependence upon decision criteria (312) includes receiving a password received (406) in a subsequent request to access a computer resource. In the example of FIG. 7 the received password has an associated time stamp identifying the day and time of the subsequent request to access the computer resource. In some cases, it may be advantageous to correct the time of the subsequent request to adjust for communication delays, differences due to asynchronous reading and writing of the time stamp and so on as will occur to those of skill in the art.

After receiving (404) a password (406) in a subsequent request to access the computer resource, the method of FIG. 7 continues by determining (400) whether the password received (406) in a subsequent request matches the provisional password (302). If the password received (406) in a subsequent request matches the provisional password (302), the method of FIG. 7 proceeds by determining (500) whether the time (506) of a subsequent request occurs within the predetermined time period. The decision rules (318) of the method of FIG. 7 include a timing requirement (502) that provides a predetermined period of time after establishing the provisional password (302) for replacing the current password (308) with the provisional password (302). The time period established by the timing requirement (502) may be seconds, minutes, days, years, or any time period that will occur to those of skill in the art. If the time (506) of the subsequent request occurs within the predetermined time period, the method of FIG. 7 continues by replacing (402) the user's current password (308) with the provisional password (302) as mentioned above. The method of FIG. 7 advantageously provides a vehicle for timing out provisional passwords.

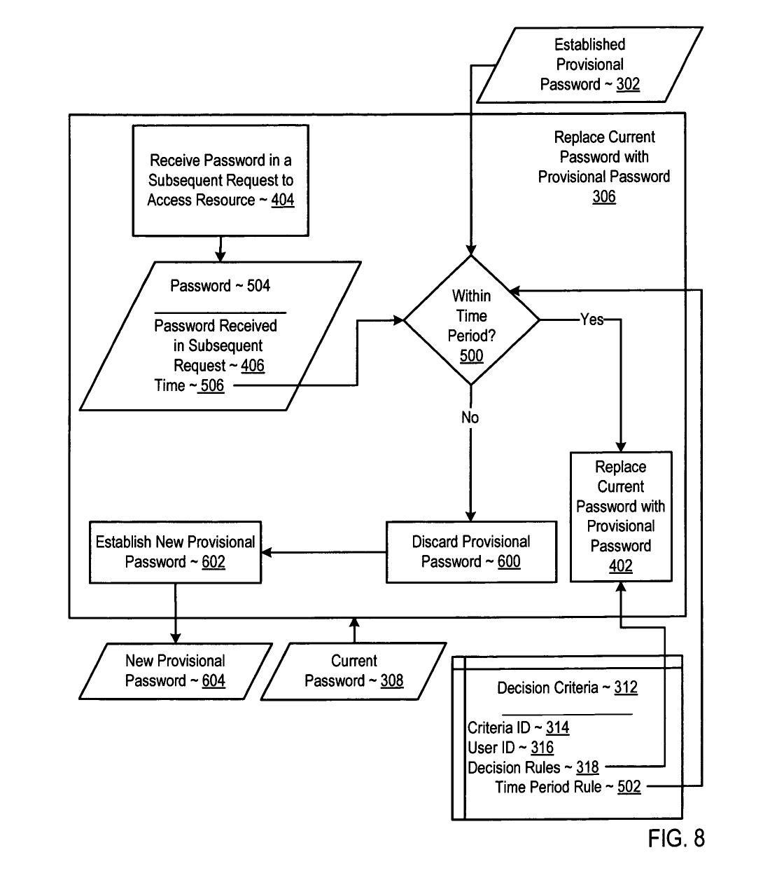

If the time (506) of the subsequent request does not occur within the predetermined time period of the timing requirement (502) of the decision rules (318), then the method of FIG. 7 continues by discarding (600) the provisional password (302) and establishing a new provisional password. For further explanation, FIG. 8 sets forth a flow chart illustrating an exemplary method for replacing (306) the user's current password (308) with the provisional password (302) in dependence upon decision criteria (312) that includes discarding (600) the provisional password (302) if a subsequent request to access the computer resource does not occur within a time period, and establishing (602) a new provisional password for the user for accessing the computer resource. The example of FIG. 8 illustrates a provisional password that is timed out.

In the method of FIG. 8, replacing (306) the user's current password (308) with the provisional password (302) in dependence upon decision criteria (312) includes receiving (404) a password (406) in a subsequent request to access the computer resource. After receiving (404) a password (406) in a subsequent request to access the computer resource, the method of FIG. 8 continues by determining (500) whether the time (506) of the subsequent request is within a predetermined time period defined in the decision criteria. The example of FIG. 8 continues by discarding (600) the provisional password (302) if the time (506) of the subsequent request does not occur within the predetermined time period of the timing requirement (502).

After discarding (600) the provisional password (302), the method of FIG. 8 further includes establishing (602) a new provisional password (604). Establishing (602) a new provisional password (604) may be carried out by verifying the user's identity, receiving a set of characters from the user, and storing the set of characters as a new provisional password (604) as mentioned above.

Exemplary embodiments of the present invention are described largely in the context of a fully functional computer system for changing a user's current password for accessing a computer resource. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for changing a user's current password for accessing a computer resource, the method comprising:
establishing a provisional password for the user for accessing the computer resource; and
replacing the user's current password with the provisional password in dependence upon decision criteria.

2. The method of claim 1 wherein replacing the user's current password with the provisional password in dependence upon decision criteria further comprises replacing the user's current password with the provisional password if the user enters the provisional password in a subsequent request to access the computer resource.

3. The method of claim 1 wherein replacing the user's current password with the provisional password in dependence upon decision criteria further comprises replacing the user's current password with the provisional password if the user enters the provisional password in a subsequent request to access the computer resource, and if the subsequent request occurs within a time period.

4. The method of claim 1 wherein replacing the user's current password with the provisional password in dependence upon decision criteria further comprises discarding the provisional password if the user does not enter the provisional password in a subsequent request to access the computer resource, and establishing a new provisional password for the user for accessing the computer resource.

5. The method of claim 1 wherein replacing the user's current password with the provisional password in dependence upon decision criteria further comprises discarding the provisional password if a subsequent request to access the computer resource does not occur within a time period, and establishing a new provisional password for the user for accessing the computer resource.

6. The method of claim 1 wherein establishing a provisional password for the user for accessing the computer resource further comprises:
verifying a user's identity in response to a user's request to access the computer resource,
receiving from the user a set of characters, and
storing the set of characters as a provisional password.

7. A apparatus for changing a user's current password for accessing a computer resource, the apparatus comprising:
a computer processor;
a computer memory coupled for data transfer to the processor, the computer memory having disposed within it computer program instructions comprising
a password administration module, the password administration module capable of:
establishing a provisional password for the user for accessing the computer resource; and
replacing the user's current password with the provisional password in dependence upon decision criteria.

8. The apparatus of claim 7 wherein the password administration module is further capable of replacing the user's current password with the provisional password if the user enters the provisional password in a subsequent request to access the computer resource.

9. The apparatus of claim 7 wherein the password administration module is further capable replacing the user's current password with the provisional password if the user enters the provisional password in a subsequent request to access the computer resource, and if the subsequent request occurs within a time period.

10. The apparatus of claim 7 wherein the password administration module is further capable discarding the provisional password if the user does not enter the provisional password in a subsequent request to access the computer resource, and establishing a new provisional password for the user for accessing the computer resource.

11. The apparatus of claim 7 wherein the password administration module is further capable discarding the provisional password if a subsequent request to access the computer resource does not occur within a time period, and establishing a new provisional password for the user for accessing the computer resource.

12. The apparatus of claim 7 wherein the password administration module is further capable
verifying a user's identity in response to a user's request to access the computer resource,
receiving from the user a set of characters, and
storing the set of characters as a provisional password.

13. A computer program product for changing a user's current password for accessing a computer resource, the computer program product disposed upon a signal bearing medium, the computer program product comprising:
computer program instructions that establish a provisional password for the user for accessing the computer resource; and
computer program instructions that replace the user's current password with the provisional password in dependence upon decision criteria.

14. The computer program product of claim 13 wherein the signal bearing medium comprises a recordable medium.

15. The computer program product of claim 13 wherein the signal bearing medium comprises a transmission medium.

16. The computer program product of claim 13 wherein computer program instructions that replace the user's current password with the provisional password in dependence upon decision criteria further comprise computer program instructions that replace the user's current password with the provisional password if the user enters the provisional password in a subsequent request to access the computer resource.

17. The computer program product of claim 13 wherein computer program instructions that replace the user's current password with the provisional password in dependence upon decision criteria further comprise computer program instructions that replace the user's current password with the provisional password if the user enters the provisional password in a subsequent request to access the computer resource, and if the subsequent request occurs within a time period.

18. The computer program product of claim 13 wherein computer program instructions that replace the user's current password with the provisional password in dependence upon decision criteria further comprise computer program instructions that discard the provisional password if the user does not enter the provisional password in a subsequent request to access the computer resource, and computer program instructions that establish a new provisional password for the user for accessing the computer resource.

19. The computer program product of claim 13 wherein computer program instructions that replace the user's current password with the provisional password in dependence upon decision criteria further comprise computer program instructions that discard the provisional password if a subsequent request to access the computer resource does not occur within a time period, and computer program instructions that establish a new provisional password for the user for accessing the computer resource.

20. The computer program product of claim 13 wherein computer program instructions that establish a provisional password for the user for accessing the computer resource further comprise:
computer program instructions that verify a user's identity in response to a user's request to access the computer resource,
computer program instructions that receive from the user a set of characters, and
computer program instructions that store the set of characters as a provisional password.
